(19) United States
(12) Patent Application Publication
(10) Pub. No.: US 2011/0243346 A1
(43) Pub. Date: Oct. 6, 2011

(54) CABLE STRUCTURES AND SYSTEMS INCLUDING SUPER-ELASTIC RODS AND METHODS FOR MAKING THE SAME

(75) Inventors: Jonathan Aase, Redwood City, CA (US); Craig Stanley, Santa Clara, CA (US)

(73) Assignee: APPLE INC., Cupertino, CA (US)

(21) Appl. No.: 13/077,003

(22) Filed: Mar. 31, 2011

Related U.S. Application Data
(60) Provisional application No. 61/319,772, filed on Mar. 31, 2010.
(60) Provisional application No. 61/384,097, filed on Sep. 17, 2010.
(60) Provisional application No. 61/326,102, filed on Apr. 20, 2010.

(51) Int. Cl. H04R 1/10; H01B 7/00; H01R 43/00

(52) U.S. Cl. 381/74; 174/71 R; 29/868

(57) ABSTRACT

A headset can include a cable structure connecting non-cable components such as jacks and headphones. The cable structure can include several legs connected at a bifurcation such as, for example, a main leg splitting into left and right legs. To prevent tangling of the cable structure, one or more rods constructed from a super-elastic material can be embedded in each of the legs. For example, a first set of superelastic rods can extend from the main leg to the left leg, a second set of superelastic rods can extend from the main leg to the right leg, and a third set of superelastic rods can extend from the left leg to the right leg. In some cases, the super-elastic rods can be incorporated in a conductor bundle used to transfer signals through the cable structure.

### CROSS-REFERENCE TO RELATED APPLICATION

This application claims the benefit of previously filed U.S. Provisional Patent Application No. 61/319,772, filed Mar. 31, 2010, entitled “Thin Audio Plug and Coaxial Routing of Wires,” U.S. Provisional Patent Application No. 61/384,097, filed Sep. 17, 2010, entitled “Cable Structures and Systems Including Super-Elastic Rods and Methods for Making the Same,” U.S. Provisional Patent Application No. 61/326,102, filed Apr. 20, 2010, entitled “Audio Plug with Core Structural Member and Conductive Rings.” Each of these provisional applications is incorporated by reference herein in their entireties.

### BACKGROUND

Wired headsets are commonly used with many portable electronic devices such as portable music players and mobile phones. Headsets can include non-cable components such as a jack, headphones, and/or a microphone and one or more cables that interconnect the non-cable components. The one or more cables can be manufactured using different approaches to limit tangling of the cables.

### SUMMARY

Cable structures and systems having super-elastic rods, and methods for manufacturing extruded cable structures that include super-elastic rods are provided.

A cable structure can include a main leg that bifurcates into a left leg and a right leg. A conductor bundle, which can include several conductive paths, can extend from the main leg into each of the left and right legs to conduct electrical signals. The cable structure can include non-cable components at each end of the cable structure to enable the transfer of information through the cable structure.

To prevent the cable structure from tangling, the cable structure can include one or more rods constructed from a super-elastic material. The rods can extend through one or two of the cable structure legs. For example, a first set of rods can extend between the the main leg and the left leg, a second set of rods can extend between the main leg and the right leg, and a third set of rods can extend between the left leg and the right leg.

Each set of rods can include any suitable number of rods. For example, a set can include a single rod of a larger diameter. As another example, a set can include several rods having smaller diameters. The number of rods in a set, as well as the size of each rod can be tuned based on a desired stiffness for each leg. In some cases, the stiffness of each leg may vary, for example based on the length of each leg, the number of conductors in the leg, the non-cable component coupled to an end of the leg, or combinations of these.

Several rods can be coupled together at each end of a leg. For example, rods from the first and second sets of rods, which extend from the main leg to the left and right legs, respectively, can be coupled together at an end of the main leg. Similarly, rods from the first and third sets can be coupled together at an end of the left leg, and rods from the second and third sets can be coupled together at the end of the right leg.

The rods can be coupled together using any suitable approach. For example, one or more of soldering, welding, brazing, an adhesive, tape, or a mechanical fastener can be used. In some cases, a plasma welding process can be used. Using the welding process, the material from the rods can combine to form a ball or other enlarged structure. The structure can then be coupled to a non-cable component to secure the rods within the cable structure. For example, a receptacle or other structure within the non-cable component can be used to receive the ball structure of the rods.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIGS. 1A and 1B illustrate different headsets having a cable structure that seamlessly integrates with non-cable components in accordance with some embodiments of the invention;

FIGS. 1C and 1D show illustrative cross-sectional views of a portion of a leg in accordance with some embodiments of the invention;

FIG. 2 is an illustrative stress-strain diagram for a super-elastic material in accordance with some embodiments of the invention;

FIGS. 3A-3E are illustrative sectional views of several cable legs in accordance with some embodiments of the invention;

FIGS. 4A-4I are illustrative sectional views of a cable leg having a super-elastic rod in accordance with some embodiments of the invention;

FIG. 5 is a perspective view of a portion of an illustrative cable leg in accordance with some embodiments of the invention;

FIG. 6 is a perspective view of a portion of an illustrative cable structure that includes several super-elastic rods in accordance with some embodiments of the invention;

FIGS. 7A-7F are schematic views of routings for a super-elastic rod in a cable structure in accordance with some embodiments of the invention;

FIG. 8A is a schematic view of super-elastic rods disposed in a cable structure in accordance with some embodiments of the invention;

FIG. 8B is a schematic view of a portion of the super-elastic rods shown in FIG. 8A in accordance with some embodiments of the invention; and

FIG. 9 is a flowchart of an illustrative process for incorporating a super-elastic rod in a cable structure in accordance with some embodiments of the invention.

### DETAILED DESCRIPTION OF THE DISCLOSURE

Cable structures for use in headsets are disclosed. The cable structure interconnects various non-cable components of a headset such as, for example, a plug, headphones, and/or a communications box to provide a headset. The cable structure can include multiple legs (e.g., a main leg, a left leg, and a right leg) that each connect to a non-cable component, and each leg may be connected to each other at a bifurcation region (e.g., a region where the main leg appears to split into the left and right legs). Cable structures according to embodiments of this invention provide aesthetically pleasing interface connections between the non-cable components and legs of the cable structure. The interface connections between a leg and a non-cable component are such that they appear to have been constructed jointly as a single piece, thereby providing a seamless interface.

In addition, because the dimensions of the non-cable components typically have a dimension that is different than the dimensions of a conductor bundle being routed through the legs of the cable structure, one or more legs of the cable structure can have a variable diameter. The change from one dimension to another is accomplished in a manner that maintains the spirit of the seamless interface connection between a leg and the non-cable component throughout the length of the leg. That is, each leg of the cable structure exhibits a substantially smooth surface, including the portion of the leg having a varying diameter. In some embodiments, the portion of the leg varying in diameter may be represented mathematically by a bump function, which requires all aspects of the variable diameter transition to be smooth. In other words, a cross-section of the variable diameter portion can show a curve or a curve profile.

The interconnection of the three legs at the bifurcation region can vary depending on how the cable structure is manufactured. In one approach, the cable structure can be a single-segment unibody cable structure. In this approach, all three legs are jointly formed and no additional processing is required to electrically couple the conductors contained therein. Construction of the single-segment cable may be such that the bifurcation region does not require any additional support. If additional support is required, an over-mold can be used to add strain relief to the bifurcation region.

In another approach, the cable structure can be a multi-segment unibody cable structure. In this approach, the legs may be manufactured as discrete segments, but require additional processing to electrically couple conductors contained therein. The segments can be joined together using a splitter. Many different splitter configurations can be used, and the use of some splitters may be based on the manufacturing process used to create the segment.

The cable structure can include a conductor bundle that extends through some or all of the legs. The conductor bundle can include conductors that interconnect various non-cable components. The conductor bundle can also include one or more rods constructed from a super-elastic material. The super-elastic rods can resist deformation to reduce or prevent tangling of the legs.

The cable structure can be constructed using many different manufacturing processes. The processes include injection molding, compression molding, and extrusion. In injection and compression molding processes, a mold is formed around a conductor bundle or a removable rod. The rod is removed after the mold is formed and a conductor bundle is threaded through the cavity. In extrusion processes, an outer shell is formed around a conductor bundle.

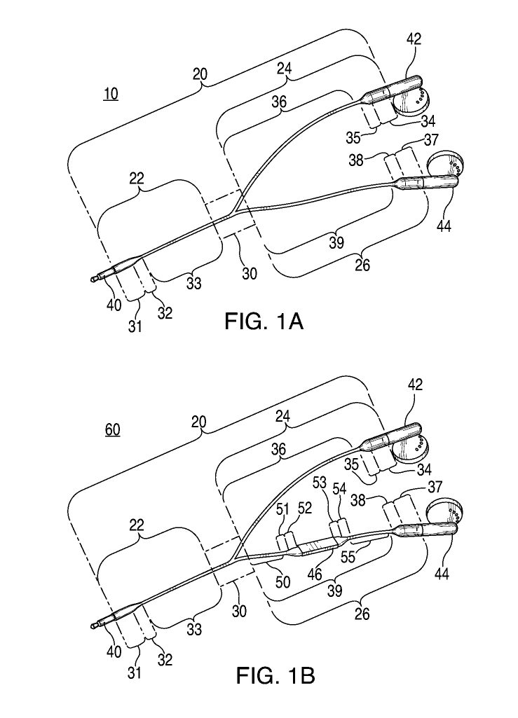

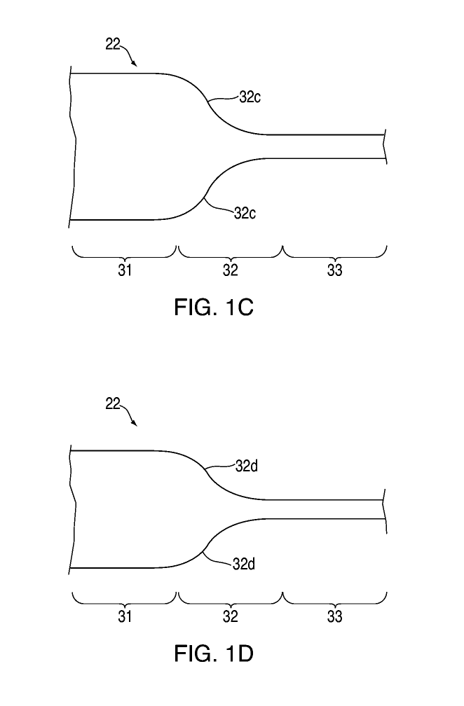

FIG. 1A shows an illustrative headset 10 having cable structure 20 that seamlessly integrates with non-cable components 40, 42, 44. For example, non-cable components 40, 42, and 44 can be a male plug, left headphones, and right headphones, respectively. Cable structure 20 has three legs 22, 24, and 26 joined together at bifurcation region 30. Leg 22 may be referred to herein as main leg 22, and includes the portion of cable structure 20 existing between non-cable component 40 and bifurcation region 30. In particular, main leg 22 includes interface region 31, bump region 32, and non-interface region 33. Leg 24 may be referred to herein as left leg 24, and includes the portion of cable structure 20 existing between non-cable component 42 and bifurcation region 30. Leg 26 may be referred to herein as right leg 26, and includes the portion of cable structure 20 existing between non-cable component 44 and bifurcation region 30. Both left and right legs 24 and 26 include respective interface regions 34 and 37, bump regions 35 and 38, and non-interface regions 36 and 39.

Legs 22, 24, and 26 generally exhibit a smooth surface throughout the entirety of their respective lengths. Each of legs 22, 24, and 26 can vary in diameter, yet still retain the smooth surface.

Non-interface regions 33, 36, and 39 can each have a predetermined diameter and length. The diameter of non-interface region 33 (of main leg 22) may be larger than or the same as the diameters of non-interface regions 36 and 39 (of left leg 24 and right leg 26, respectively). For example, leg 22 may contain a conductor bundle for both left and right legs 24 and 26 and may therefore require a greater diameter to accommodate all conductors. In some embodiments, it is desirable to manufacture non-interface regions 33, 36, and 39 to have the smallest diameter possible, for aesthetic reasons. As a result, the diameter of non-interface regions 33, 36, and 39 can be smaller than the diameter of any non-cable component (e.g., non-cable components 40, 42, and 44) physically connected to the interfacing region. Since it is desirable for cable structure 20 to seamlessly integrate with the non-cable components, the legs may vary in diameter from the non-interfacing region to the interfacing region.

Bump regions 32, 35, and 38 provide a diameter changing transition between interfacing regions 31, 34, and 37 and respective non-interfacing regions 33, 36, and 39. The diameter changing transition can take any suitable shape that exhibits a fluid or smooth transition from any interface region to its respective non-interface region. For example, the shape of the bump region can be similar to that of a cone or a neck of a wine bottle. As another example, the shape of the taper region can be stepless (i.e., there is no abrupt or dramatic step change in diameter, or no sharp angle at an end of the bump region). Bump regions 32, 35, and 38 may be mathematically represented by a bump function, which requires the entire diameter changing transition to be stepless and smooth (e.g., the bump function is continuously differentiable).

FIGS. 1C and 1D show illustrative cross-sectional views of a portion of main leg 22 in accordance with embodiments of the invention. Both FIGS. 1C and 1D show main leg 22 with a center axis (as indicated by the dashed line) and symmetric curves 32c and 32d. Curves 32c and 32d illustrate that any suitable curve profile may be used in bump region 32. Thus the outer surface of bump region 32 can be any surface that deviates from planarity in a smooth, continuous fashion.

Interface regions 21, 34, and 37 can each have a predetermined diameter and length. The diameter of any interface region can be substantially the same as the diameter of the non-cable component it is physically connected to, to provide an aesthetically pleasing seamless integration. For example, the diameter of interface region 21 can be substantially the same as the diameter of non-cable component 40. In some embodiments, the diameter of a non-cable component (e.g., component 40) and its associated interfacing region (e.g., region 31) are greater than the diameter of the non-interface region (e.g., region 33) they are connected to via the bump region (e.g., region 32). Consequently, in this embodiment, the bump region decreases in diameter from the interface region to the non-interface region.

In another embodiment, the diameter of a non-cable component (e.g., component 40) and its associated interfacing region (e.g., region 31) are less than the diameter of the non-interface region (e.g., region 33) they are connected to via the bump region (e.g., region 32). Consequently, in this embodiment, the bump region increases in diameter from the interface region to the non-interface region.

The combination of the interface and bump regions can provide strain relief for those regions of headset 10. In one embodiment, strain relief may be realized because the interface and bump regions have larger dimensions than the non-interface region and thus are more robust. These larger dimensions may also ensure that non-cable portions are securely connected to cable structure 20. Moreover, the extra girth better enables the interface and bump regions to withstand bend stresses.

The interconnection of legs 22, 24, and 26 at bifurcation region 30 can vary depending on how cable structure 20 is manufactured. In one approach, cable structure 20 can be a jointly formed multi-leg or single-segment unibody cable structure. In this approach all three legs are manufactured jointly as one continuous structure and no additional processing is required to electrically couple the conductors contained therein. That is, none of the legs are spliced to interconnect conductors at bifurcation region 30, nor are the legs manufactured separately and then later joined together. Some jointly formed multi-leg cable structures may have a top half and a bottom half, which are molded together and extend throughout the entire cable structure. For example, such jointly formed multi-leg cable structures can be manufactured using injection molding and compression molding manufacturing processes. Thus, although a mold-derived jointly formed multi-leg cable structure has two components (i.e., the top and bottom halves), it is considered a jointly formed multi-leg cable structure for the purposes of this disclosure. Other jointly formed multi-leg cable structures may exhibit a contiguous ring of material that extends throughout the entire cable structure. For example, such a jointly formed multi-leg cable structure can be manufactured using an extrusion process (discussed below in more detail).

In another approach, cable structure 20 can be a multi-segment unibody cable structure in which three discrete or independently formed legs are connected at a bifurcation region. A multi-segment unibody cable structure may have the same appearance of the jointly formed multi-leg cable structure, but the legs are manufactured as discrete components. The legs and any conductors contained therein are interconnected at bifurcation region 30. The legs can be manufactured, for example, using any of the processes used to manufacture the jointly formed multi-leg cable structure.

The cosmetics of bifurcation region 30 can be any suitable shape. In one embodiment, bifurcation region 30 can be an overmold structure that encapsulates a portion of each leg 22, 24, and 26. The overmold structure can be visually and tactically distinct from legs 22, 24, and 26. The overmold structure can be applied to the single or multi-segment unibody cable structure. In another embodiment, bifurcation region 30 can be a two-shot injection molded splitter having the same dimensions as the portion of the legs being joined together. Thus, when the legs are joined together with the splitter mold, cable structure 20 maintains its unibody aesthetics. That is, a multi-segment cable structure has the look and feel of jointly formed multi-leg cable structure even though it has three discretely manufactured legs joined together at bifurcation region 30. Many different splitter configurations can be used, and the use of some splitters may be based on the manufacturing process used to create the segment.

Cable structure 20 can include a conductor bundle that extends through some or all of legs 22, 24, and 26. Cable structure 20 can include conductors for carrying signals from non-cable component 40 to non-cable components 42 and 44. Cable structure 20 can include one or more rods constructed from a super-elastic material. The rods can resist deformation to reduce or prevent tangling of the legs. The rods are different than the conductors used to convey signals from non-cable component 40 to non-cable components 42 and 44, but share the same space within cable structure 20. Several different rod arrangements may be included in cable structure 20.

In yet another embodiment, one or more of legs 22, 24, and 26 can vary in diameter in two or more bump regions. For example, the leg 22 can include bump region 32 and another bump region (not shown) that exists at leg/bifurcation region 30. This other bump region may vary the diameter of leg 22 so that it changes in size to match the diameter of cable structure at bifurcation region 30. This other bump region can provide additional strain relief. Each leg can have any suitable diameter including, for example, a diameter in the range of 0.4 mm to 1 mm (e.g., 0.8 mm for leg 20, and 0.6 mm for legs 22 and 24).

In some embodiments, another non-cable component can be incorporated into either left leg 24 or right leg 26. As shown in FIG. 1B, headset 60 shows that non-cable component 46 is integrated within leg 26, and not at an end of a leg like non-cable components 40, 42 and 44. For example, non-cable component 46 can be a communications box that includes a microphone and a user interface (e.g., one or more mechanical or capacitive buttons). Non-cable component 46 can be electrically coupled to non-cable component 40, for example, to transfer signals between communications box 46 and one or more of non-cable components 40, 42 and 44.

Non-cable component 46 can be incorporated in non-interface region 39 of leg 26. In some cases, non-cable component 46 can have a larger size or girth than the non-interface regions of leg 26, which can cause a discontinuity at an interface between non-interface region 39 and communications box 46. To ensure that the cable maintains a seamless unibody appearance, non-interface region 39 can be replaced by first non-interface region 50, first bump region 51, first interface region 52, communications box 46, second interface region 53, second bump region 54, and second non-interface region 55.

Similar to the bump regions described above in connection with the cable structure of FIG. 1A, bump regions 51 and 54 can handle the transition from non-cable component 46 to non-interface regions 50 and 55. The transition in the bump region can take any suitable shape that exhibits a fluid or smooth transition from the interface region to the non-interface regions. For example, the shape of the taper region can be similar to that of a cone or a neck of a wine bottle.

Similar to the interface regions described above in connection with the cable structure of FIG. 1A, interface regions 52 and 53 can have a predetermined diameter and length. The diameter of the interface region is substantially the same as the diameter of non-cable component 46 to provide an aesthetically pleasing seamless integration. In addition, and as described above, the combination of the interface and bump regions can provide strain relief for those regions of headset 10.

In some embodiments, non-cable component 46 may be incorporated into a leg such as leg 26 without having bump regions 51 and 54 or interface regions 52 and 53. Thus, in this embodiment, non-interfacing regions 50 and 55 may be directly connected to non-cable component 46.

Cable structures 20 can be constructed using many different manufacturing processes. The processes discussed herein include those that can be used to manufacture the jointly formed multi-leg cable structure or legs for the multi-segment unibody cable structure. In particular, these processes include injection molding, compression molding, and extrusion. Embodiments of this invention use extrusion to manufacture a jointly formed multi-leg cable structure or multi-segment unibody cable structures.

As described above, cable structure 20 can include one or more rods for preventing or reducing tangling of the cable structure. In some cases, one or more rods constructed from a shape memory or super-elastic material such as, for example, a nickel-titanium alloy (e.g. Nitinol®), a ferromagnetic shape memory alloy, a shape memory alloy, a shape memory polymer, or another type of smart material. A super-elastic material can be characterized by super-elasticity or pseudoelasticity properties by which the material can remain elastic when it is subject to large strains.

In the case of super-elastic alloys, the ability of the material to deform elastically can be provided by a reversible solid state phase transformation between an austenite phase and a martensite phase. In particular, a super-elastic alloy is initially provided in the austenite phase. When the material is stressed, the material can transform to the martensite phase. The martensite phase can be characterized by a material structure that is capable of large deformations (i.e., large strains) without plastically modifying the material structure. In other words, as stress is applied to a super-elastic alloy, the austenite phase of the alloy initially deforms elastically, and then transforms to a martensite phase. When further stress is applied to the material, the martensite phase can deform elastically at a larger rate than the austenite phase. When the applied stress is removed from the material, the martensite phase can transform back to the austenite phase allowing the material to resume its original shape. Shape memory polymers can use a similar transition between a hard phase and a soft phase resulting from a glass transition.

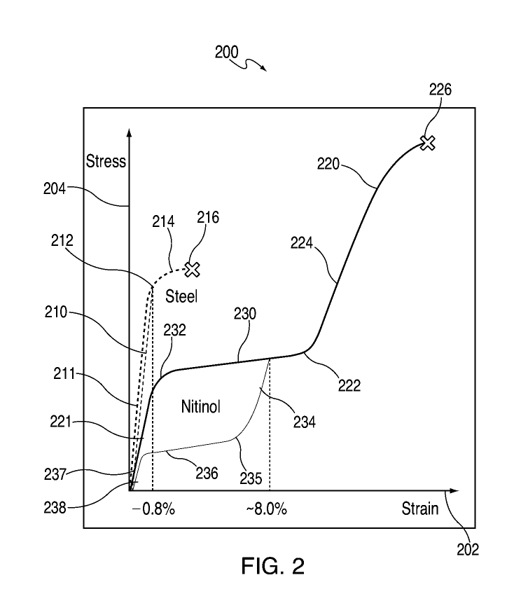

FIG. 2 is an illustrative stress-strain diagram for a super-elastic material in accordance with some embodiments of the invention. Diagram 200 includes stress-strain curve 210 corresponding to steel and stress-strain curve 220 corresponding to Nitinol®. As stress is applied to the material, indicated on axis 204, the material can deform by a strain amount, indicated on axis 202. In the case of steel, stress can be applied to the material to initially cause the steel to deform elastically, as indicated by the straight line segment 211 extending from the origin of the diagram. The slope of curve 210, which corresponds to the ratio of the stress over the strain of the curve (e.g., Young's modulus or the elastic modulus of the material), can be constant while the deformation of the material remains elastic. When the stress reaches yield stress point 212, the stress-strain relationship may evolve to a non-linear relationship. Additional stress added beyond yield stress point 212 can transform the steel in a plastic, non-reversible state, a state that will persists even if the stress is removed. As indicated by curve 210, curved section 214 of the curve is non-linear until the material fails at point 216. As shown in FIG. 2, the yield stress of steel may only allow for approximately a 0.8% strain before plastic deformation of the steel begins. This strain amount may be insufficient to permit the use of steel for the rods of conductor bundles used in cable structure 20.

Curve 220, corresponding to Nitinol®, may have a different shape than curve 210 due to the super-elastic properties of Nitinol®. Curve 220 can initially include straight segment 221, similar to segment 211 of curve 210. When curve 220 reaches a particular stress corresponding to point 232, however, curve 220 does not include a curved section corresponding to plastic deformation of the material. Instead, curve 220 includes a second straight segment 230 having a different slope than that of segment 211, indicating that the material is changing from an austenite phase to a martensite phase. In some cases, the slope of segment 230 can be substantially smaller than the slope of segment 221, indicating that the material can deform by large amounts (e.g., high strain) for small amounts of applied force (e.g., low change in stress). When the phase of the material has completely transformed to martensite, further applied stress can cause plastic deformation. In particular, point 222 can correspond to a stress and strain at which the martensite transformation is complete and at which further deformation becomes plastic. This may be seen from the shape of curved segment 224, which can be non-linear until the material fails at point 226.

So long as the material is loaded on regions of the curve up to point 222, the deformation of the material can be reversed. In some cases, however, the material may not follow the same paths 221 and 230 back towards an initial, unstressed shape. Instead, when stress is removed, the material can initially reduce the strain in the remaining austenite phase portions of the material, as indicated by curve 234. Once a particular amount of austenite phase has recovered its initial, un-strained state, for example at point 235, the material can re-transform the martensite phase of the material to the austenite phase, as indicated by curve 236. In some cases, the slope of curve 234 can match the slope of curve 221, and the slope of curve 236 can match the slope of curve 230. Once the martensite phase has been entirely transformed back to the austenite phase, for example at point 237, the material can remove the remaining strain from the austenite phase to recover its initial shape, as indicated by curve 238.

As shown by the curves of diagram 200, a super-elastic material can absorb substantially more strain without plastic deformation than a metal such as metal. In particular, Nitinol® can be subject to a strain of approximately 8% without plastic deformation, or about ten times more strain than steel. This can therefore allow a user of a cable structure having an integrated super-elastic rod to deform the cables as needed without feeling unduly restricted, while limiting tangling of the cables by a preferred, un-tangled disposition of the cable structure when no stress is provided.

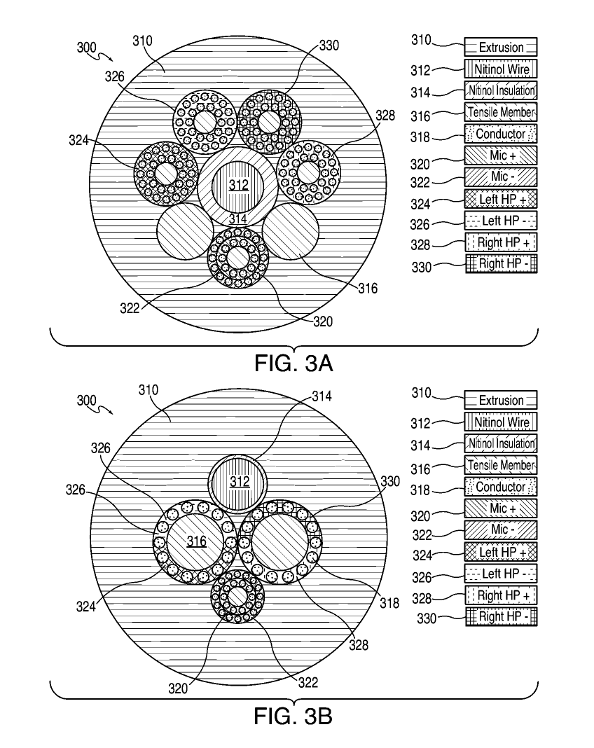

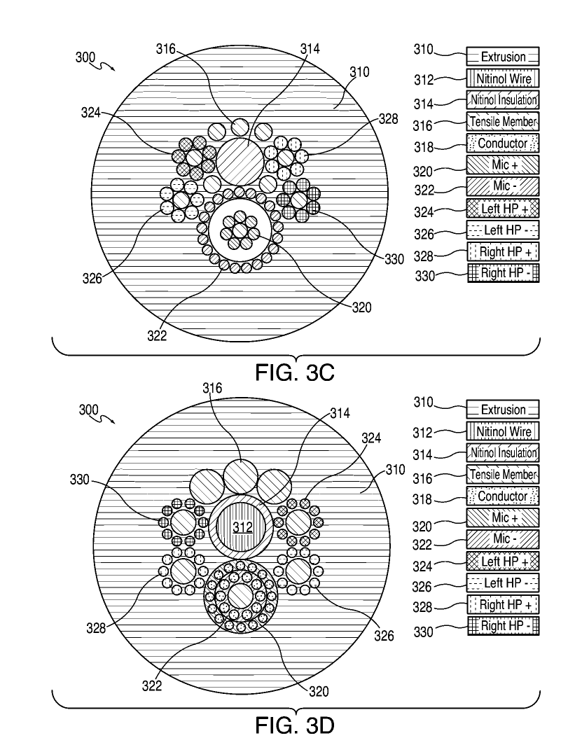

A super-elastic rod can be incorporated in a conductor bundle using different approaches. In particular, one or more super-elastic rods and one or more conductors can extend through the length of each leg. FIGS. 3A-3E are illustrative sectional views of several cable legs in accordance with some embodiments of the invention. Each cable leg 300 can include some or all of covering 310, super-elastic rod 312, rod insulation 314, tensile member 316, conductor 318, mic+ path 320, mic− path 322, left HP+ path 324, left HP− path 326, right HP+path 328, and right HP− path 330. The paths can be provided using any suitable approach. In some embodiments, each path can include an individual conductor 318 such as, for example, a wire used to transfer signals. The conductors can be constructed from any suitable material including, for example, a conductive material or a material allowing for the optical transfer of information. Each path can be associated with a single conductor, such that the cable leg includes as many conductors as paths.

In some embodiments, each path can be provided by combining several conductors to transfer a signal. In particular, several conductors associated with a single path can be routed around a tensile member as part of a coaxial bundle. For example, as shown in FIG. 3A, conductors 318 corresponding to each of paths 324, 326, 328 and 330 can be individually wrapped around tensile members 316, while conductors 318 corresponding to path 322 can be wrapped around conductors corresponding to path 320, which in turn can be wrapped around a tensile member 316. Tensile member 316 can include a strand of any suitable material providing a structure around which the conductors can be wound. Tensile member 316 can be constructed from any suitable material including, for example, a metal, plastic, composite material, or combination of these. In some cases, tensile member 316 can include a super-elastic material serving as a rod for the conductor bundle.

In some cases, conductors used to transfer signals for several paths can be routed together around a single tensile member. For example, as shown in FIG. 3B, conductors 318 corresponding to paths 324 and 326 can be routed around a tensile member 316, and conductors 318 corresponding to paths 328 and 330 can be routed around a tensile member 316. The conductors of each path can be disposed in any suitable manner relative to each other. For example, conductors corresponding to a particular path can be placed together, such that a cross-section of a coaxial bundle can include conductors from each path covering a continuous arc of the tensile member (e.g., conductors from a first path cover a first 180 degree arc, and conductors from a second path cover a second 180 degree arc). As another example, conductors corresponding to different paths can alternate around the tensile member (e.g., every other conductor of a cross-section of the coaxial bundle corresponds to a different path).

A rod constructed from a super-elastic material can be provided within the cable structure using any suitable approach. For example, the rod can be integrated as part of a conductor bundle. As another example, the rod can be provided within the cable structure independently from a conductor bundle. The rod can include any suitable coating for preventing the rod from damaging or interfering with data or power signals transferred along the conductive paths. In some cases, the rod can be covered by an insulating coating to prevent signals conducted by conductive paths from being adversely affected by the rod. Alternatively, the insulating coating can serve to prevent the rod from damaging the conductors, should the rod break due to fatigue or other mechanical failure. The insulating coating can be selected from a material that resists deformation when subject to large strains, as well as a material that is resistant to fatigue failure. The insulating coating can be constructed from any suitable material including, for example, urethane, or Kevlar. In some embodiments, a steel sheath can be used.

The rods can be provided in the cable structure using any suitable configuration. The following discussion, however, will describe the incorporation of a rod constructed from a super-elastic material in a cable structure that includes one or more conductor bundles. Some conductor bundles can include one or more rods that are independent from or combined with conductors (e.g., standalone rods or rods serving as tensile members for coaxial cable routing). In some cases, rods used in a conductor bundle can have similar or different diameters, or be constructed from the same material or different materials. The rods used for conductor bundles can be selected based on any suitable criteria including, for example, desired resistance to tangling or bending.

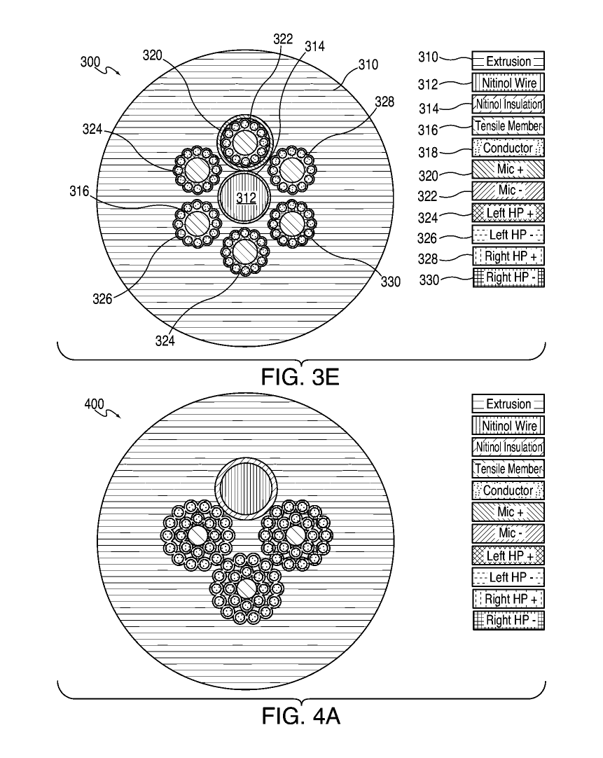

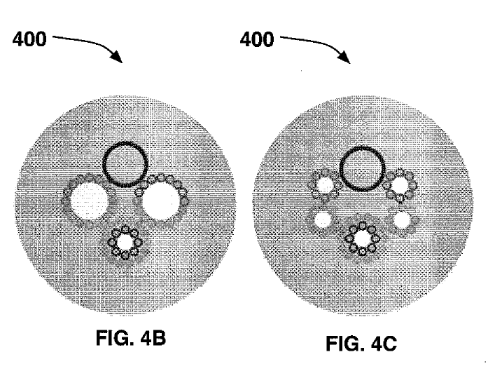

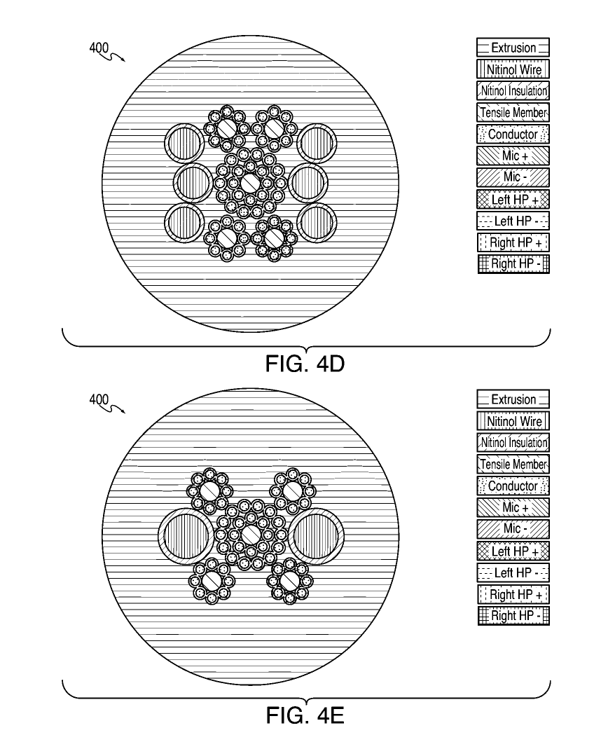

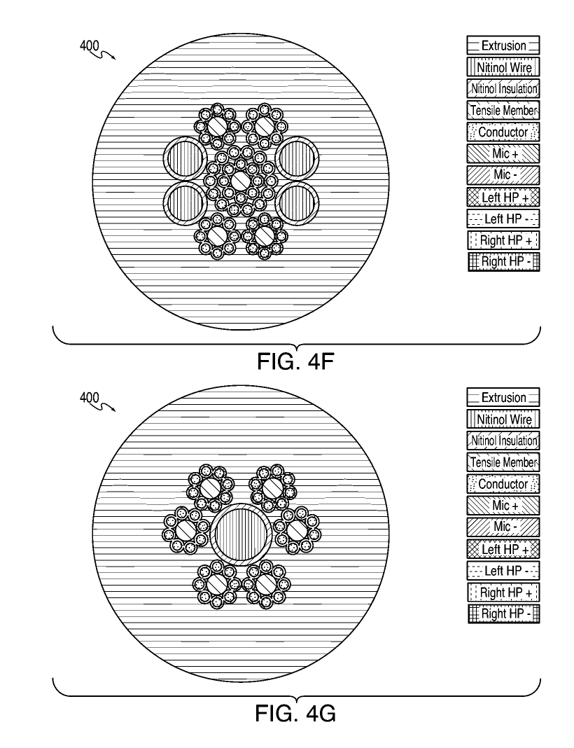

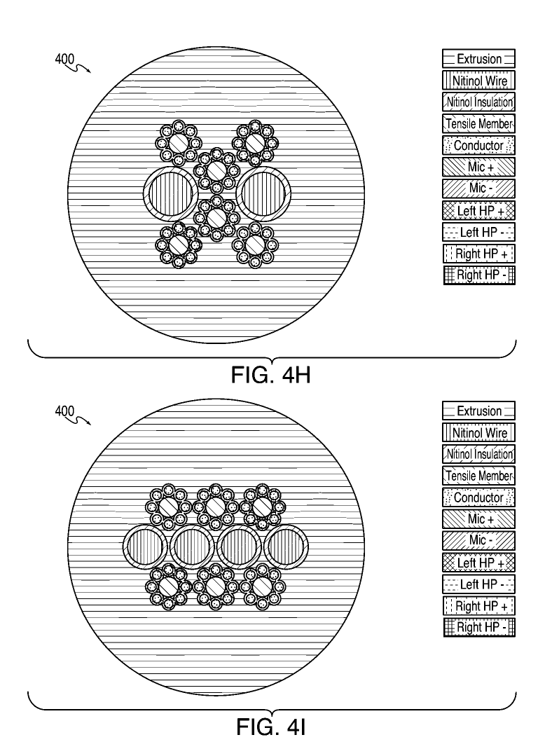

FIGS. 4A-4I are illustrative sectional views of a cable leg incorporating a super-elastic rod in accordance with some embodiments of the invention. Cable legs 400 can include any suitable component, including, for example, the conductors and rods as described above in connection with legs 300 (FIGS. 3A-3E). In some cases, a cable leg can include at least one single super-elastic rod having a diameter in the range of 0.01 inches to 0.004 inches or, for example, have a diameter of 0.009 inches, 0.0075 inches, or 0.0060 inches. A cable leg can include one super-elastic rod (e.g., FIGS. 4A-4c and 4G), two super-elastic rods (e.g., FIGS. 4E and 4H), four super-elastic rods (e.g., FIGS. 4F and 4I), or six super-elastic rods (e.g., FIG. 4D). It will be understood, however, that any suitable number of super-elastic rods can be provided. In addition, the number of super-elastic rods can change in different cross-sections of the cable structure, depending on stiffness requirements.

The rods can be disposed in any suitable manner including, for example, in a manner determined from the number of conductive paths within the bundle (e.g., three, five or six). In some cases, a super-elastic rod can be positioned near a centerline of the leg (e.g., FIG. 4G). Alternatively, the super-elastic rod can be offset from a centerline of the leg (e.g., FIGS. 4-4C). When several super-elastic rods are provided, the rods can be provided in a straight line (e.g., FIGS. 4E and 4I), in columns (e.g., FIG. 4F), on curved lines (e.g., FIG. 4D), or combinations thereof. In some cases, the super-elastic rods can be disposed in a substantially symmetrical manner to provide uniform stiffness in all bending directions.

In some cases, the properties of individual super-elastic rods used can vary based on the number of rods provided in a cable structure. For example, if several rods are provided, the rods can each have smaller diameters than a single rod designed to provide similar stiffness. In particular, as shown in FIGS. 4D, 4E, and 4F, the diameter of the rods used decreases with the total number of rods within the cable structure. This may facilitate tuning the stiffness of the cable structure, as individual wires can be swapped out to vary the stiffness of different segments of the cable structure. In addition, the stress applied to each rod may decrease, as the stress may be distributed between several rods. This may increase reliability of the cable structure by reducing failure of the super-elastic rod.

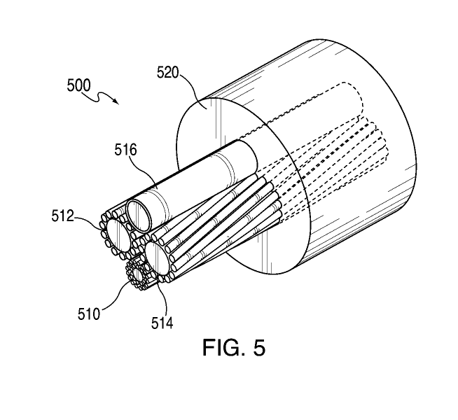

FIG. 5 is a perspective view of a portion of an illustrative cable leg in accordance with some embodiments of the invention. Leg 500 can include conductor sub-bundles 510, 512 and 514 provided as coaxial conductors around a tensile member (e.g., coaxial bundles), and super-elastic rod 516 placed within covering 520. Each element of the cable leg can be disposed such that the conductor sub-bundles and super-elastic rod are substantially centered within the leg (e.g., evenly spaced around a centerline of covering 520).

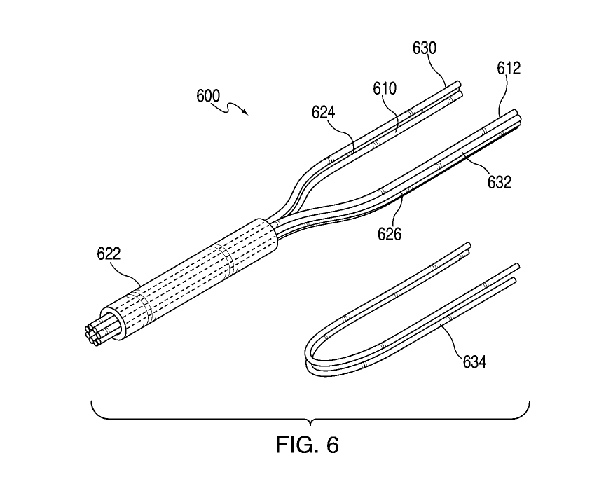

Individual super-elastic rods can be routed in the cable structure using any suitable approach. FIG. 6 is a perspective view of a portion of an illustrative cable structure that includes several super-elastic rods in accordance with some embodiments of the invention. Structure 600 can include main leg 622, left leg 624, and right leg 626. Conductive paths 610 and 612 can be routed along the legs to ensure the proper transfer of data through cable structure 600. To prevent tangling of the cable structure, primary rods 630 and 632 can be routed from main leg 622 to left leg 624 and right leg 626, respectively. To further enhance the resistance of the cable structure, secondary rod 634 can be routed through left leg 624 and right leg 626. It will in addition be understood that each rod identified above can be replaced by several rods. For example, cable structure 600 can include two parallel rods 630 and 632. In addition, cable structure 600 can include three individual rods routed as indicated by rod 634.

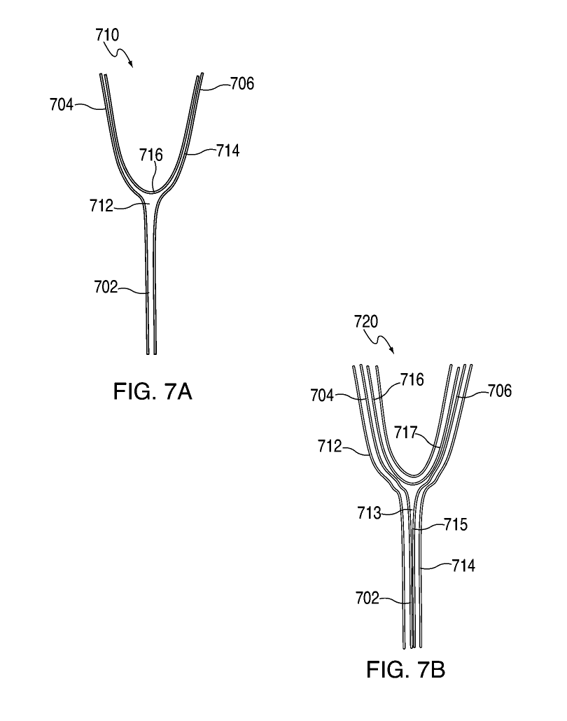

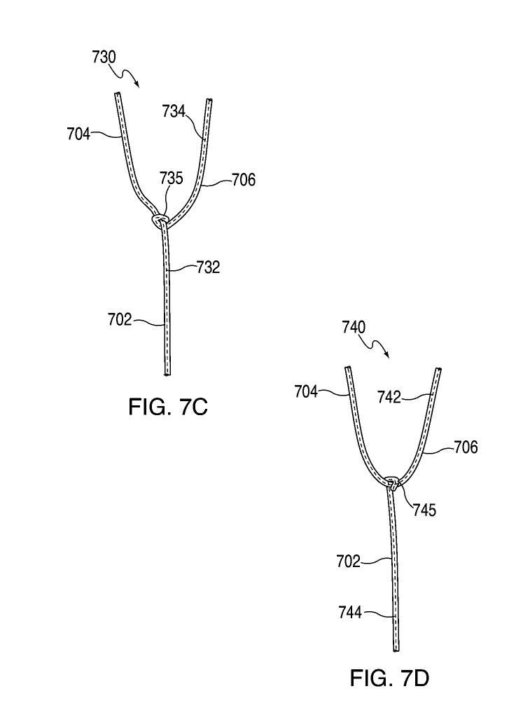

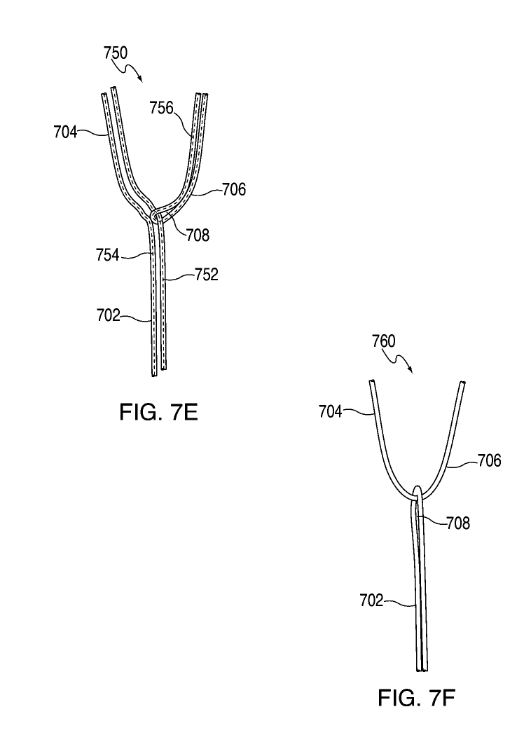

Other approaches can be used to route super-elastic rods within the cable structure. FIGS. 7A-7F are schematic views of routings for a super-elastic rod in a cable structure in accordance with some embodiments of the invention. The super-elastic rods described in the following discussion can include some or all of the features of the super-elastic rods described herein. In some cases, a super-elastic rod can include several rods in parallel (e.g., smaller diameter rods disposed parallel to each other to form a set of rods). Structure 710 can include main leg 702, left leg 704, and right leg 706. To reduce tangling of the cable structure, cable structure 710 can include super-elastic rod 712 extending from main leg 702 to left leg 704 and super-elastic rod 714 extending from main leg 702 to right leg 706. In addition, structure 710 can include super-elastic rod 716 extending between left leg 704 and right leg 706 in substantially a U-shape. In some cases, cable structure 710 may not include super-elastic rod 716.

In some cases, a single super-elastic rod can be complemented with additional super-elastic rods disposed within a cable structure. Cable structure 720, shown in FIG. 7B, can include super-elastic rods 712 and 713 disposed in parallel and extending from main leg 702 to left leg 704, and super-elastic rods 714 and 715 disposed in parallel and extending from main leg 702 to right leg 706. In addition, structure 710 can include U-shaped super-elastic rods 716 and 717 extending between left leg 704 and right leg 706. By doubling the number of rods from structure 710 in structure 720, the resulting structure may be more resistant to tangling. In some cases, the diameter of the rods of structure 720 can be smaller than the diameter of the rods of structure 710 to ensure that the conductive bundles of each structure fit within a desired exterior diameter of the cable structure or to reduce the stress to each rod. Any suitable number of rods, having any suitable combination of enlarged or reduced diameters (e.g., relative to single rods disposed as shown in FIG. 7A), can be provided as a set or rods instead of the individual rods shown in FIG. 7B.

In some cases, different super-elastic rods of a cable structure can be coupled to each other. Cable structure 730, shown in FIG. 7C, can include super-elastic rod 732 extending from main leg 702 to left leg 704. In addition, cable structure 730 can include super-elastic rod 734 extending through right leg 706. Super-elastic rod 734 can include loop 735 through which super-elastic rod 732 can pass. Loop 735 can be constructed using different approaches including, for example, bending the material of rod 734 to form a loop, and soldering, welding, or gluing the loop closed. Loop 735 can have any suitable size including, for example, a size that enables super-elastic rod 732 to slide through the loop. In some cases, loop 735 can instead be crimped or sized to secure super-elastic rod 734 to super-elastic rod 732 (e.g., via a press fit).

The super-elastic rod having the loop can be incorporated in any leg of the cable structure. For example, as shown in cable structure 740 of FIG. 7D, super-elastic rod 742 can extend between left leg 704 and right leg 706, and super-elastic rod 744 can extend through main leg 702. Super-elastic rod 744 can include loop 745 having some or all of the properties of loop 735 (FIG. 7C). To connect super-elastic rod 742 to super-elastic rod 744, super-elastic rod 742 can pass through loop 745.

In some cases, two distinct rods can be secured to each other without creating a closed loop in one of the rods. This may be desirable, for example, to reduce the processing required to construct the super-elastic rod with a loop. Cable structure 750, shown in FIG. 7E, can include super-elastic rods 752 and 754 placed in parallel and extending from main leg 702 to left leg 704. Cable structure 750 can also include super-elastic rod 756 extending through right leg 706. Super-elastic rod 756 can be routed around at least one of super-elastic rods 752 and 754 at bifurcation region 708 of cable structure 750 so that super-elastic rod 756 in effect provides two distinct rods in right leg 706 (e.g., both ends of super-elastic rod 756 extend from a non-cable end of right leg 706). This may enable cable structure 750 to have a consistent stiffness, as each leg may include two super-elastic rods. In some cases, the diameter or other mechanical property of one or more of the super-elastic rods can differ to provide a desired resistance to tangling.

FIG. 7F shows cable structure 760 includes super-elastic rod 762 extending through main leg 702 and super-elastic rod extending between left leg 704 and right leg 706. Similar to super-elastic rod 756 of cable structure 750, super-elastic rod 762 can be routed around super-elastic rod 764 at bifurcation 708 such that both ends of super-elastic rod 762 extend from a non-cable component end of main leg 702. In some cases, super-elastic rods 762 and 764 can include similar diameters, such that the doubled-back super-elastic rod 762 of main leg 702 and the single super-elastic rod 764 of left leg 704 and right leg 706 provide different resistance to tangling. In some cases, the diameter of super-elastic rod 762 can be smaller than the diameter of super-elastic rod 764 such that the anti-tangling properties provided by the super-elastic rods are substantially the same in each of main leg 702, left leg 704, and right leg 706.

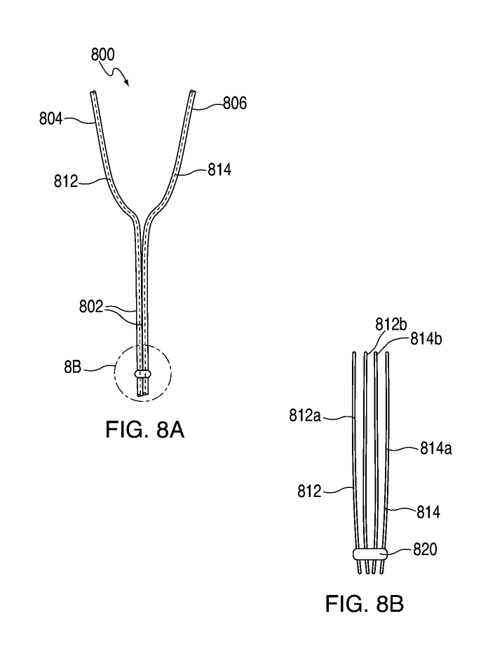

As discussed above, in some cases a cable leg can include several super-elastic rods extending parallel to one another. As the rods of a set of rods reach an end of the leg where an interface region provides a connection with a non-cable component, the rods may need to terminate in a manner that will secure the rods and prevent the rods from damaging the interface region and the non-cable component, as well as an electrical connection provided with the non-cable component. FIG. 8A is a schematic view of super-elastic rods disposed in a cable structure in accordance with some embodiments of the invention. FIG. 8B is a schematic view of a portion of the super-elastic rods shown in FIG. 8A in accordance with some embodiments of the invention. Cable structure 800 can include main leg 802, left leg 804, and right leg 806, which can include some or all of the features of cable structures described above.

To prevent tangling of the cable structure, cable structure 800 can include several super-elastic rods extending through one or more legs of the structure. For example, rod 812 can extend from main leg 802 to left leg 804, and rod 814 can extend from main leg 802 to right leg 806. Although only two rods are shown in cable structure 800, it will be understood that any suitable configuration of rods can be provided. Each of rods 812 and 814 can, in some cases, include a single rod or a combination of several rods placed in parallel. For example, rod 812 can include two rods 812a and 812b, and rod 814 can include two rods 814a and 814b, as shown in FIG. 8B.

While electrical connectors may terminate by being connected to a non-cable component at an end of the cable structure, the super-elastic rods may not be electrically coupled to the non-cable components. When the cable structure is deformed however, the super-elastic rods can move relative to the non-cable component, and relative to each other at an end of the cable structure. This can damage the cable structure, for example by causing a rod to pierce through an outer surface of the cable structure or cut a conductor. It may therefore be desirable to couple several rods together at their termination.

Many different approaches can be used to connect the ends of several rods together. For example, the rods can be glued together. As another example, the rods can be welded (e.g., laser welded), soldered, or brazing together. As still another example, a mechanical fastener such as a rivet, bolt, screw, or clip can be used.

In some cases, it may be desirable to create a structure at the end of the rods to couple the rods to a non-cable component. For example, a housing for a plug or an earphone can include at least one groove, hemisphere, receptacle, or other feature in which at least one ball of material corresponding to a set of rods can be received. In the example of FIG. 8B, each of rods 812a, 812b, 814a, and 814b can be coupled together by ball 820 of material. In some cases, the rods can in part be bent towards each other to reduce the free space between the rods within ball 820. Ball 820 can have any suitable size. In some cases, the dimensions or number of balls 820 can be determined from the number, disposition, and size of rods to couple together, dimensions of the non-cable component receiving the rods, structural attributes of the bond retaining the rods, or combinations of these.

Ball 820 can be constructed using any of the approaches described above. In some cases, however, a plasma arc welding process (PAW) can be used. This process can ensure a strong bond between the rods by causing portions of the rods to melt and combine in the weld region. In addition, the bond may be strong in shear to prevent individual rods from translating relative to one another along the axis of the rods.

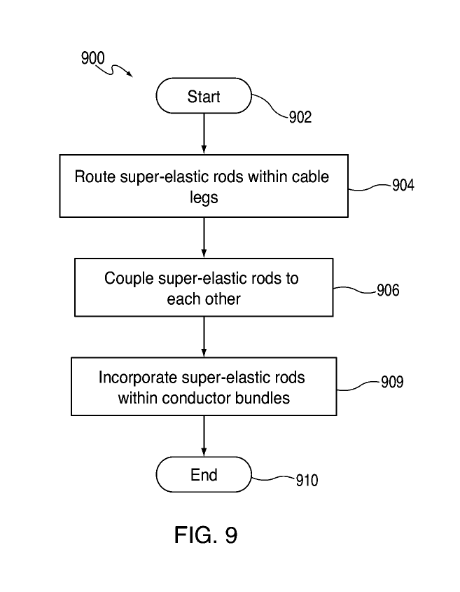

FIG. 9 is a flowchart of an illustrative process for incorporating a super-elastic rod in a cable structure in accordance with some embodiments of the invention. Process 900 can begin at step 902. At step 904, at least one super-elastic rod can be routed within cable legs. For example, super-elastic rods can be placed within a mold used to create the cable structure. As another example, super-elastic rods can be fed through tubing associated with legs of the cable structure. At step 906, super-elastic legs can be coupled to each other. For example, a super-elastic rod can be threaded through an open loop in another super-elastic rod. As another example, a super-elastic rod can be routed around another super-elastic rod. In cable structures where super-elastic rods are kept in parallel, cases, step 906 may be ignored. At step 909, super-elastic rods can be incorporated within conductor bundles. For example, super-elastic rods can be aligned with conductors, tensile members, or wires to form conductor bundles. Process 900 can then end at step 910.

It should be understood that processes of FIG. 9 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A cable structure comprising:
a main leg coupled to left and right legs at a bifurcation region;
a plurality of conductors routed from the main leg to the left leg and from the main leg to the right leg;
a first rod, constructed from a super-elastic material, extending from the main leg to the left leg;
a second rod, constructed from a super-elastic material, extending from the main leg to the right leg; and
a third rod, constructed from a super-elastic material, extending from the left leg to the right leg.

2. The cable structure of claim 1, wherein:
the first rod is coupled to the second rod at an end of the main leg.

3. The cable structure of claim 1, wherein:
the first rod is coupled to the third rod at an end of the left leg.

4. The cable structure of claim 1, wherein:
the second rod is coupled to the third rod at an end of the right leg.

5. The cable structure of claim 1, further comprising:
at least one other rod placed adjacent to and extending parallel the first rod.

6. The cable structure of claim 5, wherein:
the first rod and the at least one other rod have a substantially same diameter.

7. The cable structure of claim 5, wherein:
ends of the first rod and the at least one other rod are coupled together.

8. The cable structure of claim 1, further comprising:
a non-cable component coupled to an end of the main leg, wherein:
one of the plurality of conductors is electrically coupled to the non-cable component; and
the first and second rods are secured to the non-cable component.

9. The cable structure of claim 8, further comprising:
melting portions of the first and second rods to create a ball adjacent to an end of the first and second rods; and
engaging the ball with a portion of the non-cable component.

10. A method for constructing a cable structure, comprising:
providing a plurality of conductors operative to transfer at least one of data and power signals, wherein the plurality of conductors are routed from a main leg to left and right legs;
providing a plurality of super-elastic rods adjacent to the conductors to form a bundle, wherein at least one super-elastic rod is placed along the left leg and the right leg; and
placing the bundle of plurality of conductors and plurality of super-elastic legs in an outer shell to form a cable structure.

11. The method of claim 10, wherein:
the shell comprises a cosmetic outer surface.

12. The method of claim 10, wherein coupling further comprises:
defining a ball comprising portions of each of the at least two of the plurality of super-elastic rods.

13. The method of claim 12, wherein defining the ball further comprises:
coupling together at least two of the plurality of super-elastic rods that are adjacent to each other near an end of a leg to define a ball using plasma arc welding.

14. The method of claim 12, further comprising:
electrically coupling a non-cable component to the at least one conductor bundle at an end of a leg of the cable structure; and
securing the defined ball to the non-cable component.

15. The method of claim 14, further comprising:
defining a feature in the non-cable component for receiving the ball.

16. A headset, comprising:
a plurality of conductors operative to transfer signals from an end of a main leg to an end of a left leg and an end of a right leg;
an audio plug coupled to the plurality of conductors at the end of the main leg;
a first audio output component coupled to the plurality of conductors at the end of the left leg;
a second audio output component coupled to the plurality of conductors at the end of the left leg;
at least one super-elastic rod having a first end coupled to the first audio output component and a second end coupled to the second audio output component; and
a cosmetic outer shell placed over the plurality of conductors and the at least one super-elastic component.

17. The cable structure of claim 16, further comprising:
at least one super-elastic rod having a first end coupled to the audio plug.

18. The cable structure of claim 16, further comprising:
at least two super-elastic rods placed adjacent to each other near the end of the main leg; and
a ball structure coupling together the at least two super-elastic rods.

19. The cable structure of claim 18, wherein:
the audio plug comprises a receptacle for receiving the ball structure.

20. The cable structure of claim 16, wherein:
the at least one super-elastic rod is constructed from Nitinol®.
